(19) United States
(12) Patent Application Publication
(10) Pub. No.: US 2026/0309409 A1
(43) Pub. Date: Oct. 8, 2026

(54) METHODS AND SYSTEMS FOR EFFICIENT PRESSURIZED LIQUEFIED NATURAL GAS (PLNG) PRODUCTION, DELIVERY, AND USE ACROSS MOBILE AND STATIONARY APPLICATIONS

(71) Applicant: Cryosys, LLC, Houston, TX (US)

(72) Inventors: Donald J. VICTORY, Sugar Land, TX (US); William Larry LEWIS, Tomball, TX (US)

(21) Appl. No.: 19/170,806

(22) Filed: Apr. 4, 2025

(51) Int. Cl. F25J 1/00; F17C 5/02; F25J 3/08

(52) U.S. Cl. CPC F25J 1/0022; F17C 5/02; F25J 3/08; F17C 2221/033; F17C 2270/0105; F25J 2210/62; F25J 2230/30

(57) ABSTRACT

Methods and systems for the production, storage, transport, and utilization of pressurized liquefied natural gas (PLNG) at pressures of 6 bar-g to 20 bar-g across mobile and stationary applications. Methods and systems for dynamically managing pressures within a PLNG supply chain to maintain pressures of 6 bar-g to 20 bar-g across the PLNG supply chain.

### BACKGROUND

### Field

Embodiments disclosed herein generally relate to methods and systems for the production, storage, transport, and utilization of pressurized liquefied natural gas (PLNG) at pressures of 6 bar-g to 20 bar-g across mobile and stationary applications.

### Description of the Related Art

The increasing demand for sustainable energy solutions has intensified interest in liquefied natural gas (LNG) systems for fuel applications. LNG has long been a key enabler for mobile applications, such as trucks and marine vessels, as well as stationary applications, including power generation and local gas grids. However, traditional LNG systems require energy-intensive liquefaction at −160° C., extensive pretreatment to remove CO₂ below 50 ppm, and cryogenic infrastructure, limiting efficiency, scalability, and environmental performance. These include high-energy requirements for liquefaction, extensive gas pretreatment processes, and reliance on cryogenic storage and delivery infrastructure.

As such, there is a need for methods and systems for efficient production, delivery, and use of LNG.

### SUMMARY

In one embodiment, a pressurized liquefied natural gas (PLNG) system for producing, storing, transporting, and utilizing PLNG for mobile applications comprises a production system configured to receive natural gas and produce PLNG at a pressure within a range of 6 bar-g to 20 bar-g; and a mobile fuel system configured to receive the PLNG from the production system and maintain the PLNG at the pressure within the range of 6 bar-g to 20 bar-g.

In one embodiment, a pressurized liquefied natural gas (PLNG) system for producing, storing, land-vehicle transporting, and utilizing PLNG for stationary applications comprises a production system configured to receive natural gas and produce PLNG at a pressure within a range of 6 bar-g to 20 bar-g; and a stationary system configured to receive the PLNG from the production system and maintain the PLNG at the pressure within the range of 6 bar-g to 20 bar-g.

In one embodiment, a method of dynamically managing pressures within a pressurized liquefied natural gas (PLNG) supply chain comprises monitoring one or more operational conditions of a pressurized tank containing PLNG at a pressure within a range of 6 bar-g to 20 bar-g via one or more sensors; receiving a signal corresponding to the one or more operational conditions from the one or more sensors; and adjusting pressure within the pressurized tank based on the one or more operational conditions.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A illustrates a schematic view of a section of a PLNG supply chain for mobile land vehicles, according to one or more embodiments.

FIG. 1B illustrates a schematic view of another section of the PLNG supply chain for mobile land vehicles, according to one or more embodiments.

FIG. 1C illustrates a schematic view of another section of the PLNG supply chain for mobile land vehicles, according to one or more embodiments.

FIG. 1D illustrates a schematic view of another section of the PLNG supply chain for mobile land vehicles, according to one or more embodiments.

FIG. 2A illustrates a schematic view of a section of a PLNG supply chain for marine vessels, according to one or more embodiments.

FIG. 2B illustrates a schematic view of another section of the PLNG supply chain for marine vessels, according to one or more embodiments.

FIG. 3A illustrates a schematic view of a section of a PLNG supply chain using land transport vehicles to deliver PLNG to remote stationary application, according to one or more embodiments.

FIG. 3B illustrates a schematic view of another section of the PLNG supply chain using land transport vehicles to deliver PLNG to remote stationary application, according to one or more embodiments.

FIG. 3C illustrates a schematic view of another section of the PLNG supply chain using land transport vehicles to deliver PLNG to remote stationary application, according to one or more embodiments.

FIG. 3D illustrates a schematic view of another section of the PLNG supply chain using land transport vehicles to deliver PLNG to remote stationary application, according to one or more embodiments.

FIG. 4A illustrates a schematic view of a section of a PLNG supply chain for marine vessels with marine bunkering, according to one or more embodiments.

FIG. 4B illustrates a schematic view of another section of the PLNG supply chain for marine vessels with marine bunkering, according to one or more embodiments.

FIG. 4C illustrates a schematic view of another section of the PLNG supply chain for marine vessels with marine bunkering, according to one or more embodiments.

FIG. 5 illustrates a schematic view of an optional pre-processing system, according to one or more embodiments.

FIG. 6 illustrates an integrated PLNG liquefier with a natural gas liquids and heavy hydrocarbon recovery system, and a nitrogen recovery system, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Traditional liquefied natural gas (LNG) systems liquefy natural gas at near-atmospheric pressures and temperatures as low as −160° C. (~113 K). However, achieving these conditions requires significant energy input, making liquefaction one of the most energy-intensive steps in the LNG value chain. Furthermore, traditional LNG systems demand extensive gas pretreatment to avoid freezing of impurities during liquefaction. Typical specifications include carbon dioxide (CO₂) removal to below 50 ppm and heavy hydrocarbon (HHC) removal to prevent freeze-out at cryogenic temperatures. Heavy hydrocarbons is typically defined as C5+, including but not limited to aliphatic hydrocarbons such as pentane, hexane, heptane, and molecules with more carbon atoms, as well as aromatic hydrocarbons such as benzene, toluene, ethylbenzene, and xylenes (the latter four sometimes collectively referred to as the “BTEX”). These requirements necessitate complex equipment, such as mole sieve absorption systems, amine absorption systems, and cryogenic distillation systems, which add capital and operational costs. In addition, LNG is typically produced into storage tanks at pressures of 5 bar-g or lower. Conventional cryogenic trucks and trailers are commonly rated at 65 or 75 psig (~4.5-5 bar-g). No known LNG value chain operates consistently at or above 6 bar-g across production, transport, and consumption. The limiting factor is often the pressure rating of transport trucks and trailers.

In contrast to traditional LNG, pressurized liquefied natural gas (PLNG) has several advantages that overcome the shortcomings of traditional LNG. Operating at elevated pressures between 6 bar-g (~87 psi-g) and 20 bar-g (~290 psi-g), PLNG can be liquefied at higher temperatures, reducing energy intensity and greenhouse gas emissions (GHGe). Maintaining pressures of 6 bar-g or higher throughout the PLNG value chain reduces energy intensity and GHGe intensity, potentially increasing liquefaction capacity by over 40% with the same refrigeration power. Moreover, higher pressures improve the solubility of impurities, such as CO₂ and HHCs (e.g. benzene), reducing or eliminating the need for complex pretreatment systems.

### Approximate Bubble Point Temperatures at Different Pressures

| Pressure | Pressure | Bubble Point | Bubble Point |
|---|---|---|---|
| (bar-g) | (psi-g) | Temperature (° C.) | Temperature (° F.) |
| 0 | ~0 | ~−160° C. | ~−256° F. |
| 6 | ~87 | ~−120° C. | ~−184° F. |
| 10 | ~145 | ~−118° C. | ~−180° F. |
| 16 | ~232 | ~−112° C. | ~−170° F. |
| 20 | ~290 | ~−110° C. | ~−166° F. |

### Pressure, Temperature, and Impurity Solubility in PLNG Systems

| | | Approximate | CO₂ Solubility | Benzene | |
|---|---|---|---|---|---|
| Pressure | Pressure | Temperature | Threshold | Solubility | |
| (bar-g) | (psi-g) | (° C.) | (mole %) | Threshold (ppm) | |
| 0 | ~0 | ~−160° C. | ~0.02% | ~0.1 | ppm |
| 6 | ~87 | ~−120° C. | ~0.8% | ~50 | ppm |
| 10 | ~145 | ~−118° C. | ~1.0% | ~100 | ppm |
| 16 | ~232 | ~−112° C. | ~1.6-1.7% | ~300 | ppm |
| 20 | ~290 | ~−110° C. | ~2.0% | ~400 | ppm |

By maintaining elevated pressures, PLNG systems significantly reduce the energy required for refrigeration and relax pretreatment requirements. For example, at 16 bar-g, CO₂ solubility increases to 1.6-1.7%, allowing for its partial retention in the gas stream, reducing or eliminating the need for amine absorption systems. For further example, benzene solubility thresholds at higher pressures and temperatures reduce the likelihood of freeze-out, further simplifying the PLNG value chain.

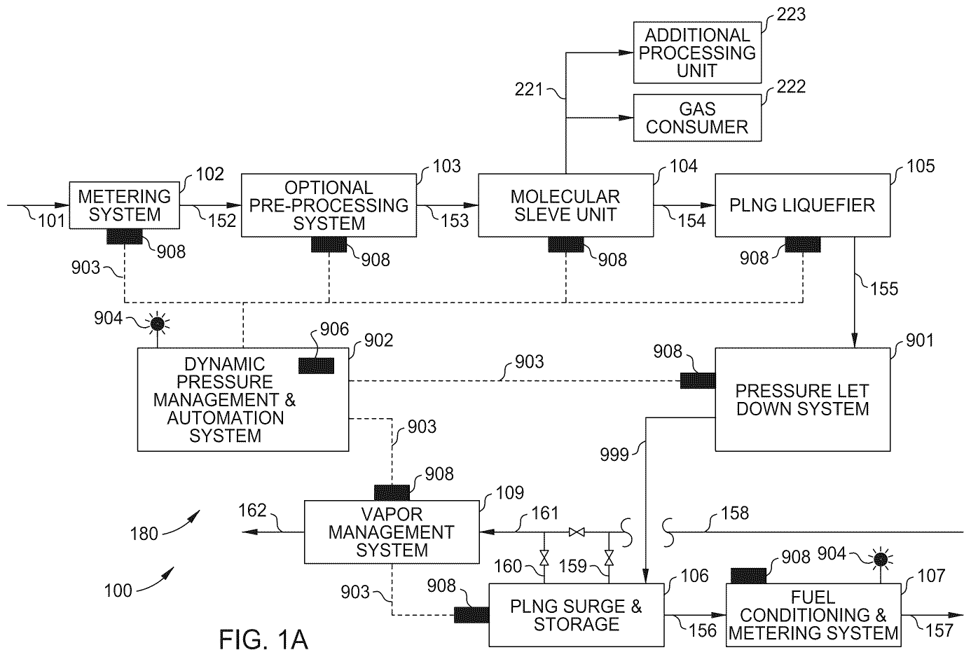

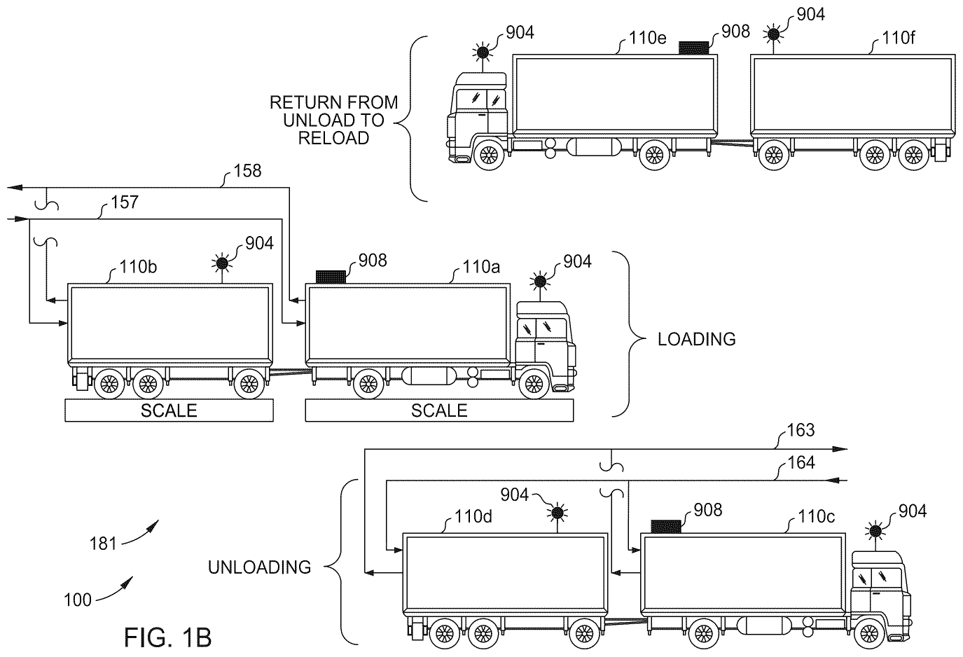

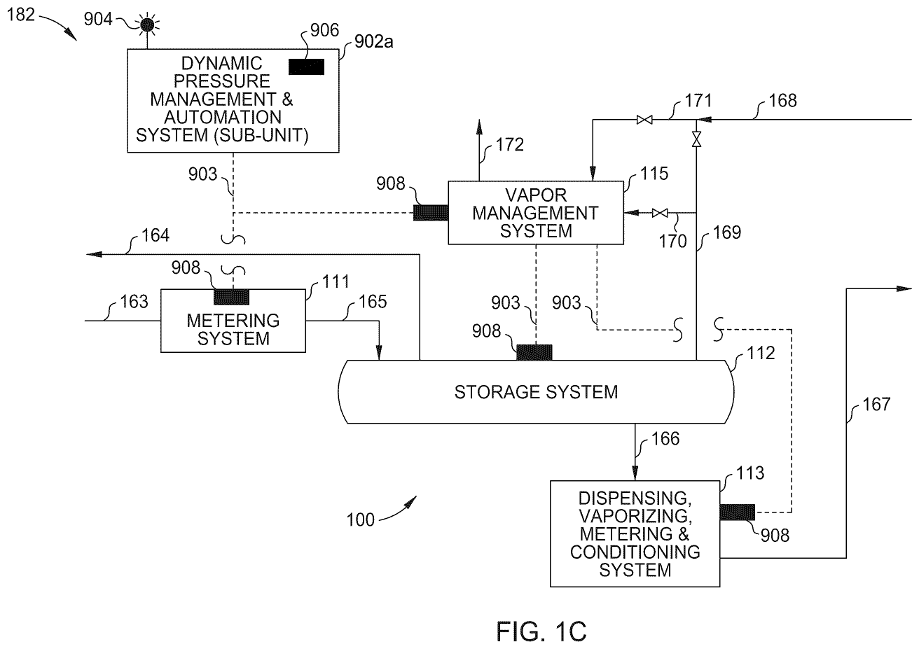

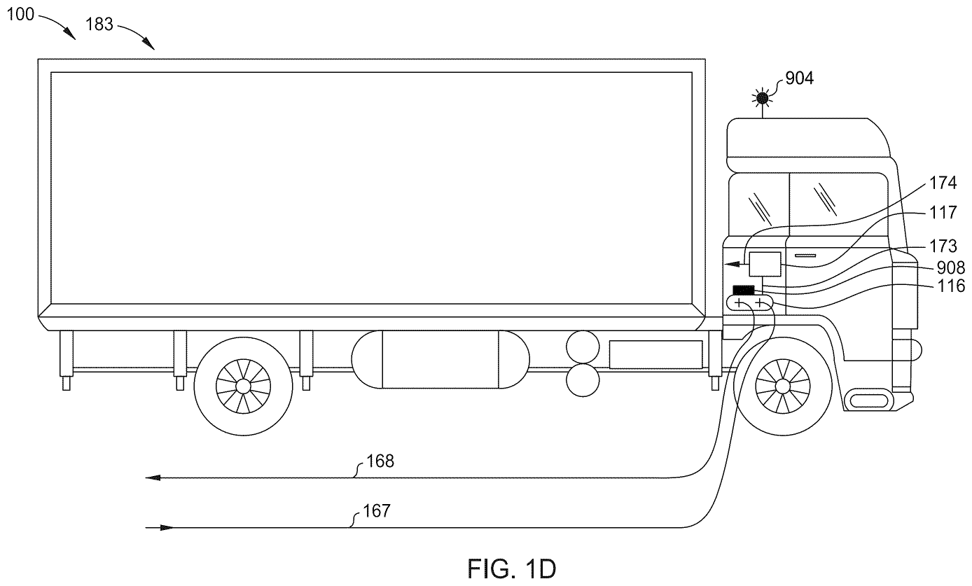

Embodiments of this disclosure illustrated and described below with respect to FIGS. 1A-6 comprise fully integrated methods and systems for pressurized liquefied natural gas (PLNG) production, transport, and use across diverse mobile and stationary applications. For example, embodiments of this disclosure comprise methods and systems for the production, storage, transport, and utilization of PLNG as a fuel for mobile applications, such as large vehicles, marine vessels, and stationary use cases, while reducing greenhouse gas emissions and energy consumption. Embodiment of this disclosure comprise an integrated PLNG value chain that maintains elevated pressures throughout, significantly improving operational efficiency, scalability, and reliability compared to traditional LNG systems.

According to one or more embodiments, the PLNG systems operate at pressures ranging from 6 bar-g (~87 psi-g) to 20 bar-g (~290 psi-g), enabling warmer liquefaction temperatures (−110° C. to −120° C.) and reducing refrigeration energy demands. This pressure range optimizes system efficiency while maintaining safe and consistent operations across the PLNG value chain.

According to one or more embodiments, the PLNG systems leverage molecular sieve technology to perform dehydration and, optionally, the removal of CO₂ and HHCs. This approach minimizes or eliminates the need for chemical amine absorption systems, reducing capital costs, operational complexity, and energy consumption. Impurities are managed to remain within acceptable thresholds for PLNG, further simplifying the overall process.

According to one or more embodiments, the PLNG systems comprise a comprehensive pressure management system, incorporating: continuous monitoring of tank pressures and temperatures throughout the production, storage, transport, and delivery stages; automatic adjustments to maintain optimal operating pressures, preventing conditions near relief valve thresholds and minimizing or eliminating fugitive methane emissions; and coordination between system components to ensure consistent performance and energy efficiency across the entire value chain.

According to one or more embodiments, the PLNG systems can be used for mobile applications, such as land vehicles and marine vessels, as well as stationary uses, including backup power generation or integration into local gas grids, demonstrating broad adaptability and potential for diverse fuel delivery needs.

FIGS. 1A-1D illustrate schematic views of different sections of a pressurized liquefied natural gas (PLNG) supply chain 100 for mobile land vehicles, according to one or more embodiments. The PLNG supply chain 100 is designed to deliver fuel in the form of PLNG for use in mobile land vehicle applications.

FIG. 1A illustrates a PLNG production system 180 of the PLNG supply chain 100. FIG. 1B illustrates a PLNG transfer system 181 of the PLNG supply chain 100. FIG. 1C illustrates a PLNG storage system 182 of the PLNG supply chain 100. FIG. 1D illustrates a mobile vehicle 183 configured to use PLNG from the PLNG supply chain 100.

With reference to FIG. 1A, the PLNG production system 180 of the PLNG supply chain 100 includes an inlet stream 101, which comprises a natural gas feedstock entering the PLNG production system 180 and forming the starting point of the PLNG supply chain 100. The inlet stream 101 flows through an inlet metering system 102, which measures properties of the natural gas feedstock that are used for system operations and accounting control, e.g., flow rate, composition, temperature, pressure, energy content, etc.

The inlet stream 101 flows via fluid line 152 to an optional pre-processing system 103, which may comprise one or more sub-systems configured in various orders depending on site-specific needs.

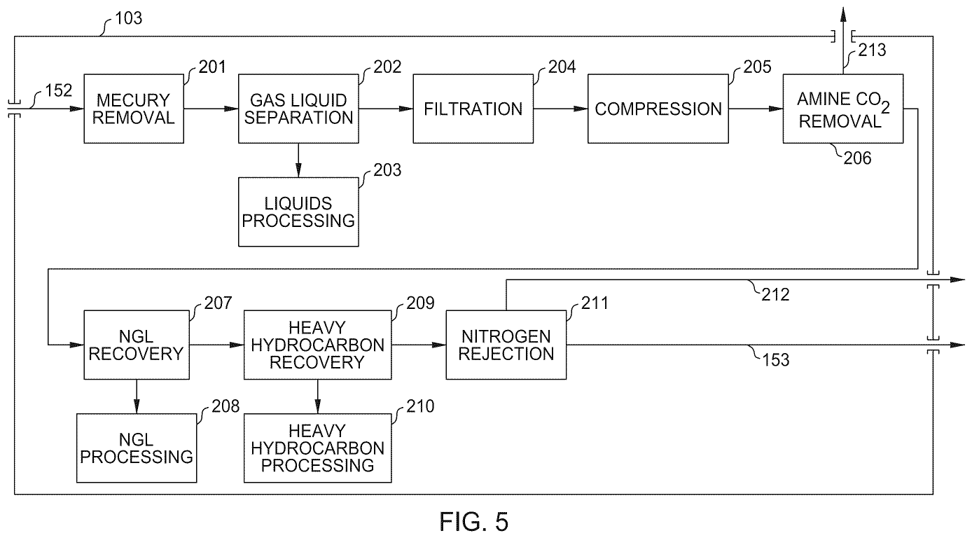

FIG. 5 illustrates the optional pre-processing system 103, according to one or more embodiments. With reference to FIG. 5, the sub-systems may comprise a mercury removal sub-system 201 configured to remove mercury from the inlet stream 101 since trace mercury can mechanically degrade components such as aluminum heat exchangers. The sub-systems may comprise a gas-liquid separation sub-system 202 configured to remove entrained liquids in the inlet stream 101. The entrained liquids may be sent to a liquids processing sub-system 203. The sub-systems may comprise a filtration sub-system 204 to filter particulate matter from the inlet stream 101. The sub-systems may comprise a compression sub-system 205 to ensure the pressure of the inlet stream 101 is sufficient for PLNG production.

The sub-systems may comprise an amine absorption unit 206 to trim carbon dioxide levels from the inlet stream 101, which above a certain level may freeze in the PLNG liquefier 105 (shown in FIG. 1A). The carbon dioxide can be sent via fluid line 213 to a carbon dioxide disposal unit or for further processing. The sub-systems may comprise a natural gas liquids (NGLs) recovery unit 207 to recover natural gas liquids from the inlet stream 101, using a number of established processes such as cryogenic separation, etc. The NGLs can be sent to an NGL processing sub-system 208 for further processing. The sub-systems may comprise a heavy hydrocarbon recovery unit 209 to recover heavy hydrocarbons from the inlet stream 101, which above a certain level may freeze in the PLNG liquefier 105, using a number of established processes such as mole sieve adsorption, cryogenic separation, etc. The heavy hydrocarbons can be sent to a heavy hydrocarbon processing sub-system 210 for further processing. The sub-systems may comprise one or more nitrogen rejection units 211 to trim nitrogen content from the inlet stream 101 using a number of established processes such as a cryogenic process, pressure swing absorption, membranes, etc. The nitrogen can be sent via fluid line 212 for further processing. The subsystems of the pre-processing system 103 are in fluid communication with each other and may be ordered in a fashion to obtain an optimal pre-processing result, and some of the subsystems may be synergized, all to lower capital and operating cost including energy consumption. For one example, one process may comprise mercury removal on a two-phase stream, while another process may comprise gas-liquid separation and mercury removal on separate gas and liquid streams. A second example is that cryogenic processing may be used in more than one sub-system, so those processes can be heating and cooling integrated and auxiliary systems such as refrigeration may be deployed across multiple sub-systems. The pre-processing system 103 may therefore also operate as a contaminant removal system. The processed inlet stream 101 can then flow out of the pre-processing system 103 via fluid line 153.

With reference back to FIG. 1A, if needed, the processed inlet stream 101 then continues it flow via fluid line 153 to a molecular sieve unit 104, which may dehydrate the processed inlet stream 101 to prevent freezing of water vapor during liquefaction of the natural gas feedstock, and/or trim CO₂ and/or HHC content. The molecular sieve unit 104 may therefore also operate as a contaminant removal system. The processed inlet stream 101 may be dried to 1 ppm water content or less to prevent freezing. Depending on PLNG production pressure, CO₂ levels may not need to be removed entirely. For the processed inlet stream 101, CO₂ levels of 0.6-1.7% may be acceptable (compared to the 50-200 ppm required for traditional LNG). Lastly, mole sieves or another process can be used to trim HHC levels in the processed inlet stream 101 to avoid solidification at PLNG product temperatures. The molecular sieve unit 104 may be configured to only remove contaminants from the natural gas feedstock in the processed inlet stream 101 at a reduced level, comprising carbon dioxide removal only down to a level of 0.8 mole percent for a PLNG product at 6 bar-g and up to 2.0 mole percent for a PLNG product at 20 bar-g, as well as benzene removal only down to a level of 50 ppm benzene for a PLNG product at 6 bar-g and up to 400 ppm benzene for a PLNG product at 20 bar-g. The molecular sieve unit 104 may also comprise a regeneration gas system configured to regenerate the molecular sieve unit 104 using heated gas, and route regeneration gas containing removed contaminants via fluid line 221 to a natural gas consumer 222 (e.g. a gas engine or a gas pipeline) and/or to an additional processing unit 223.

The processed inlet stream 101 then continues it flow via fluid line 154 to a PLNG liquefier 105, which cools and liquefies the processed inlet stream 101 into PLNG, typically at as high an operating pressures as practical to reduce the energy of liquefaction, and certainly at a pressure above the desired product PLNG pressure of 6 bar-g to 20 bar-g. The PLNG liquefier 105 may use any conventional refrigeration cycles (single mixed refrigerant, dual mixed refrigerant, propane precooled mixed refrigerant, cascade refrigerants, methane expansion cycles, nitrogen expander cycle, etc.) modified to operate at the warmer PLNG temperatures (e.g., −110° C. to −120° C.).

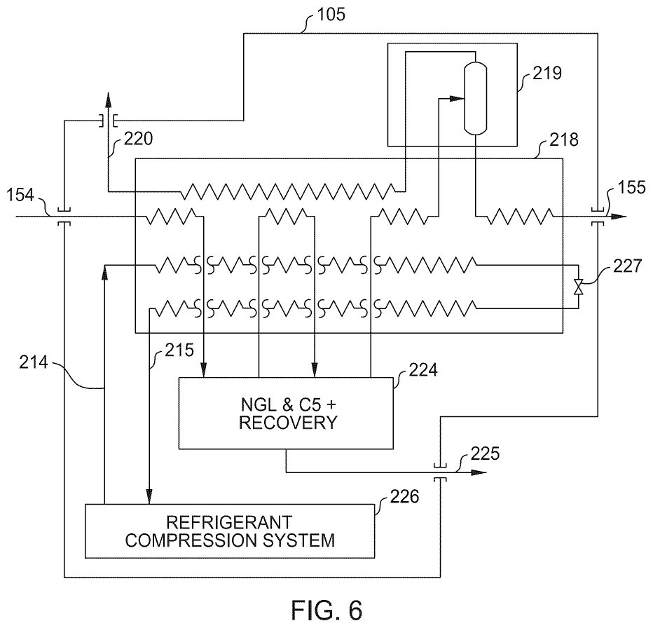

Some fuel standards and engine manufacturers may specify a maximum nitrogen content in natural gas in liquefied form, for example, one percent. Therefore, if the natural gas feedstock in the inlet stream 101 flowing to a PLNG production facility has more nitrogen than the amount of the fuel specification or fuel standard allow, it must be reduced if that PLNG product is to fuel such engines. The nitrogen can be removed via the optional pre-processing system 103 as discussed above. An alternative is to integrate a nitrogen recovery system and/or a NGL and heavy hydrocarbon recovery system into the PLNG liquefier 105 as illustrated in FIG. 6. With reference to FIG. 6, the processed inlet stream 101 flows via fluid line 154 into a cryogenic heat/cool exchange system 218 and is circulated through a NGL and heavy hydrocarbon recovery unit 224. NGLs and heavy hydrocarbons may be removed from the processed inlet stream 101 and directed out of the PLNG liquefier 105 via fluid line 225 for further processing. The processed inlet stream 101 flows back through the cryogenic heat/cool exchange system 218 and to a gas liquid separator 219, which operates as a nitrogen recovery system. Nitrogen, being a lighter component than methane, is more difficult to liquefy. After partial liquefaction of the natural gas feedstock in the processed inlet stream 101 by the gas liquid separator 219, a liquid stream, which will tend to be richer in methane and other hydrocarbons, and leaner in nitrogen, flows back through the cryogenic heat/cool exchange system 218 then out of the PLNG liquefier 105 via fluid line 155. A vapor stream, which will be richer in nitrogen and leaner in methane and other hydrocarbons, is separated and flows back through the cryogenic heat/cool exchange system 218 then out of the PLNG liquefier 105 via fluid line 220. The vapor stream, which is a nitrogen-rich stream, can have its cold recovered and, since it can still have some hydrocarbons, can be routed via fluid line 220 as fuel gas that can be used onsite or near site by natural gas consuming devices. The PLNG liquefier 105 may comprise a refrigerant compression system 226 that supplies refrigerant via fluid line 214 to the cryogenic heat/cool exchange system 218, then to a refrigerant pressure let down system 227, then back through the cryogenic heat/cool exchange system 218, then back to the refrigerant compression system 226 via fluid line 215. The refrigerant can cool the processed inlet stream 101 flowing through the cryogenic heat/cool exchange system 218. The PLNG liquefier 105 may therefore also operate as a contaminant removal system.

With reference back to FIG. 1A, the processed inlet stream 101, which is in the form of PLNG, departing the PLNG liquefier 105 via fluid line 155 is now cold, pressurized, condensed, and preferably subcooled and is routed to a pressure let down system 901. The pressure let down system 901 may be an adiabatic (non-energy recovery) device, such as a throttle valve, or an isentropic (work recovering) device, such as a hydraulic let down turbine. The pressure let down system 901 is regulated so that after flow through fluid line 999 the desired pressure is obtained in a PLNG surge and storage system 106.

The processed inlet stream 101, which is in the form of PLNG, flows via fluid line 999 to the PLNG surge and storage system 106, which contains one or more insulated tanks to buffer and store the PLNG (e.g. 6 bar-g or higher, such as within a pressure range of 6 bar-g to 20 bar-g), minimizing heat leak and vaporization to ensure continuous operations.

The processed inlet stream 101, now in the PLNG form, flows via fluid line 156 to a fuel conditioning and metering system 107, which may comprise one or more pump systems to facilitate PLNG flow through one or more transfer lines (illustrated as fluid line 157) and enable efficient loading of transport vehicles (illustrated in FIG. 1B as PLNG transport vehicles 110a-110f). The fuel conditioning and metering system 107 may further comprise temperature conditioning to adjust PLNG temperature when it may be directly or indirectly loaded into consumer fuel tanks. The fuel conditioning and metering system 107 may further comprise custody-transfer metering to ensure accurate measurement for operational and business accounting.

As the PLNG is pumped via fluid line 157 into a transport vehicle, and specifically into a tank of a transport vehicle (at 6 bar-g or higher, such as within a pressure range of 6 bar-g to 20 bar-g), one or more vapor return lines (illustrated as fluid line 158) may be use to manage displaced vapor from the tank of the transport vehicle, ensuring minimal methane emissions. The vapor flows through fluid lines 158, 161, and possibly other components, to a vapor management system 109, which handles the displaced vapor (such as boil-off gas (BOG)) during tank filling, storage, and transfer. By starting at elevated pressures (6 bar-g or higher), compression requirements for routing the displaced vapor (e.g. BOG) via fluid line 162 to nearby consumers are reduced or eliminated.

In addition to or alternatively, displaced vapor from the tank of the transport vehicle may be directed into the one or more tanks of the PLNG surge and storage system 106 via fluid lines 159, 160. Similarly, as the one or more tanks of the PLNG surge and storage system 106 are filled with PLNG, displaced vapor may flow through fluid lines 159, 160, 161 to the vapor management system 109. Any of the fluid lines 158, 159, 160, 161 may be equipped with control valves to control flow to the various systems as needed.

The PLNG production system 180 may also include a dynamic pressure management and automation system 902, e.g. a control system, for managing and dynamically adjusting pressures within the various systems of the PLNG supply chain 100. The dynamic pressure management and automation system 902 may include a control unit 906 in communication with one or more sensors 908 configured to measure, pressure, temperature, and other conditions of state within the various systems, and send signals via communication lines 903 to the control unit 906 corresponding to the pressure and temperature measurements. In addition, or alternatively, one or more of the sensors 908 can communicate with the control unit 906 using telemetry via one or more antennas 904.

The control unit 906 is configured to receive the signals corresponding to pressure and temperature level measurements from the one or more sensors 908, and actuate one or more pressure and flow regulating devices. The pressure and flow regulating devices may include the pressure let down system 901 and/or one or more control valves configured to control the flow and/or the pressure within the fluid lines and/or within the various systems of the PLNG supply chain 100. The control unit 906 can monitor and actuate the pressure let down system 901, and/or any of the other one or more pressure and flow regulating devices equipped on the various system components, such as the tanks, by sending a signal through the communication lines 903 and/or through telemetry via the one or more antennas 904. Upon receiving a signal from the control unit 906, the pressure and flow regulating devices can then adjust the pressure within the various systems.

With the ability to monitor and adjust pressures, the dynamic pressure management and automation system 902 can be configured to minimize boil-off rates of the PLNG within the various systems, such as in any of the one or more transport and/or storage tanks, during transport and/or storage. The dynamic pressure management and automation system 902 can also be configured to minimize pressure drop within the various systems, such as during transfer of the PLNG to or from the transport and/or storage tanks. The dynamic pressure management and automation system 902 can also be configured to ensure compatibility with end-user systems operating at elevated pressures. The dynamic pressure management and automation system 902 can also be configured to prevent overpressure conditions and methane emissions from the transport and/or storage tanks. The dynamic pressure management and automation system 902 can also be configured to ensure compatibility with fuel systems in mobile or stationary applications.

With reference to FIG. 1B, the PLNG transfer system 181 of the PLNG supply chain 100 includes the PLNG transport vehicles 110a-110f. PLNG is pumped into and out of the PLNG transport vehicles 110a-110f, which may be specialized trucks and trailers equipped with insulated tanks designed for cryogenic temperatures and PLNG pressures (e.g. 6 bar-g or higher, such as within a pressure range of 6 bar-g to 20 bar-g) to transport the PLNG to additional storage and/or direct to consumer sites. When pumping PLNG into the PLNG transport vehicles 110a, 110b (e.g. loading) via fluid line 157, vapor that is displaced from the PLNG transport vehicles 110a, 110b can be returned via fluid line 158 and other components eventually to the vapor management system 109 and/or the PLNG surge and storage system 106 illustrated in FIG. 1A. When pumping PLNG out of the PLNG transport vehicles 110c, 110d (e.g. unloading), the PLNG may flow out via fluid line 163, while vapor flows back into the PLNG transport vehicles 110c, 110d via fluid line 164. The PLNG transport vehicles 110e, 110f can then return from unloading to reload. One or more of the PLNG transport vehicles 110a-110f may also include the sensors 908 configured to measure the pressure within the transport tanks, and communicate with the control unit 906 of the dynamic pressure management and automation system 902 (illustrated in FIG. 1A) using telemetry via one or more antennas 904. The control unit 906 can monitor the transport tanks of the PLNG transport vehicles 110a-110f by sending a signal through telemetry via the one or more antennas 904 as part of the protocols for maintaining operational efficiency and integrity.

With reference to FIG. 1C, the PLNG storage system 182 comprises receiving facilities and a metering system for receiving, storing, and dispensing PLNG. The PLNG storage system 182 includes one or more PLNG transfer lines (illustrated as fluid line 163) that flow through a metering system 111 to a storage system 112 (comprising one or more tanks configured to store the PLNG at 6 bar-g or higher, such as within a pressure range of 6 bar-g to 20 bar-g) via fluid line 165. The metering system 111 may include Coriolis meters. The storage system 112 may be a consumer-end storage system that buffers and stores PLNG at 6 bar-g or higher before distribution or consumption. One or more vapor return lines (illustrated as fluid line 164) may receive displaced vapor from the storage system 112 and send the displaced vapor to the tanks of the PLNG transport vehicles 110c, 110d (illustrated in FIG. 1B). In addition, or alternatively, the displaced vapor can also be directed to a vapor management system 115, via fluid lines 169, 170, which manages displaced and boil-off vapor at the consumer site for example, routing the vapor to local consumers or processing the vapor as needed via fluid line 172. Displaced vapor from mobile vehicles can also be directed to the vapor management system 115 via fluid lines 168, 171.

The PLNG in the storage system 112 can be pumped via fluid line 166 to a dispensing, metering, and PLNG dispensing, vaporizing, metering, and conditioning system 113, which dispenses the PLNG to mobile vehicles or stationary consumers via fluid line 167. The system 113 may include pumps, one or more vaporizer coils most commonly referred to as a “pressure-building coil” (PBC), metering systems, and temperature conditioning. Proper conditioning ensures that the PLNG is delivered at the required pressure and temperature, minimizing operational disruptions and maximizing fuel efficiency.

The PLNG storage system 182 may also include a dynamic pressure management and automation system subunit 902a for managing and dynamically adjusting pressures within the PLNG storage system 182. The dynamic pressure management and automation system subunit 902a operates in a similar manner as the dynamic pressure management and automation system 902 illustrated in FIG. 1A, and communicates via communication lines 903 and/or one or more antennas 904 between the control unit 906, the sensors 908, and the pressure and flow regulating devices. The dynamic pressure management and automation system subunit 902a can also communicate with the dynamic pressure management and automation system 902 illustrated in FIG. 1A via the one or more antennas 904 to share one or more operational conditions, such as pressure and temperature measurements, of the various components of the systems. Based on the operational conditions of the various components of the systems, such as pressure and temperature, the dynamic pressure management and automation system subunit 902a can take automated actions to manage condition where such capability has been designed into the PLNG storage system 182, or advise system operators to possible operations activities to manage pressure, which may include an increase in the frequency of loading fuel to consumers vehicles.

With reference to FIG. 1D, the PLNG can be pumped via fluid line 167 to a mobile fuel system, illustrated as a mobile vehicle 183, and specifically to one or more PLNG on-board fuel tanks 116 designed to store PLNG at operating pressures (e.g. 6 bar-g or higher, such as within a pressure range of 6 bar-g to 20 bar-g) and temperatures to fuel the engine of the mobile vehicle 183 (which may supplement or replace diesel fuel for example). PLNG may flow from the PLNG on-board fuel tank 116 to a fuel management system 117 via fluid line 173, which pressurizes, vaporizes, and heats the PLNG fuel for delivery to the engine via fluid line 174. Displaced vapor from the PLNG on-board fuel tank 116 may be returned via fluid line 168 to the vapor management system 115 illustrated in FIG. 1C.

The mobile vehicle 183 can also be equipped with one or more sensors 908 configured to measure the pressure and temperature levels within the PLNG on-board fuel tank 116, one or more pressure and flow regulating devices configured to adjust the pressure within the PLNG on-board fuel tank 116, and one or more antennas 904 configured to communicate with the control unit 906 of the dynamic pressure management and automation system 902 illustrated in FIG. 1A.

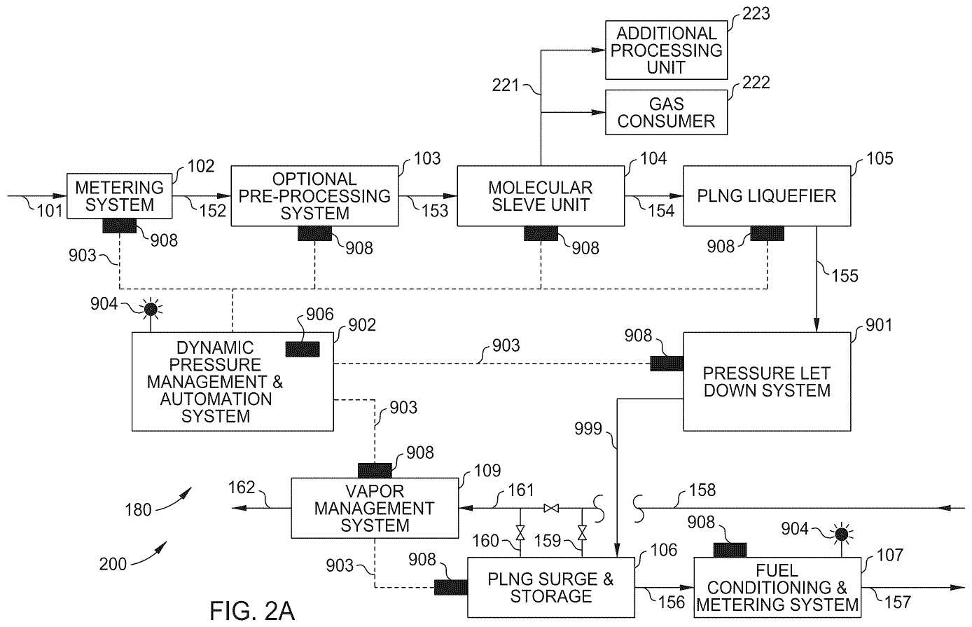

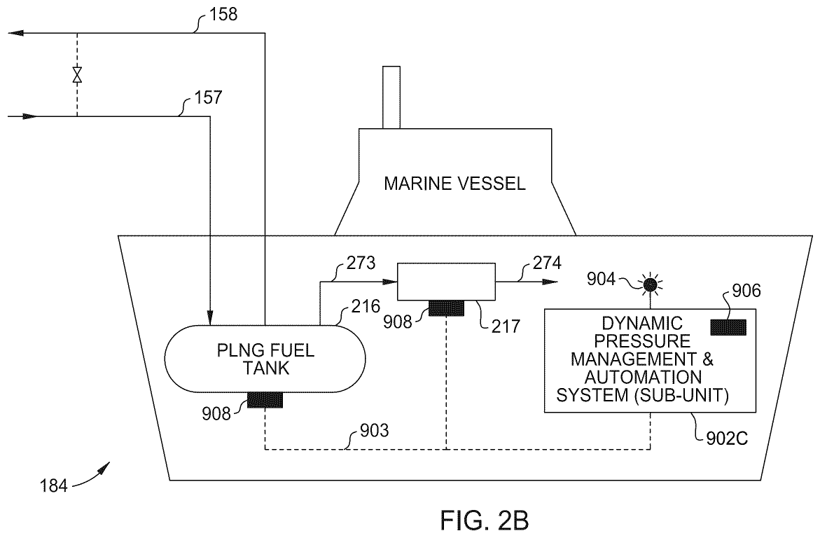

FIGS. 2A and 2B illustrate a schematic view of a PLNG supply chain 200 for marine vessels, according to one or more embodiments. The PLNG supply chain 200 includes the same PLNG production system 180 as in the PLNG supply chain 100 and illustrated in FIG. 1A. A full description of the PLNG production system 180 will not be repeated herein for brevity.

With reference to FIGS. 2A and 2B, the PLNG can be pumped via fluid line 157 to a marine vessel 184, and specifically to one or more PLNG on-board fuel tanks 216 designed to store PLNG at operating pressures (e.g. 6 bar-g or higher, such as within a pressure range of 6 bar-g to 20 bar-g) and temperatures to fuel the engine of the marine vessel 184. PLNG may flow from the PLNG on-board fuel tank 216 to a fuel management system 217 via fluid line 273, which pressurizes, vaporizes, and heats the PLNG fuel for delivery to the engine via fluid line 274. Displaced vapor from the PLNG on-board fuel tank 216 may be returned via fluid line 158 to the vapor management system 109.

The marine vessel 184 may also include a dynamic pressure management and automation system subunit 902c for managing and dynamically adjusting pressures within the marine vessel 184. The dynamic pressure management and automation system subunit 902c operates in a similar manner as the dynamic pressure management and automation system 902 (illustrated in FIG. 1A), and communicates via communication lines 903 and/or one or more antennas 904 between the control unit 906, the sensors 908, and the pressure and flow regulating devices. The dynamic pressure management and automation system subunit 902c can also communicate with the dynamic pressure management and automation system 902 via the one or more antennas 904 to share one or more operational conditions, such as pressure and temperature measurements, of the various components of the marine vessel 184. Based on the operational conditions of the various systems, such as pressure and temperature, the dynamic pressure management and automation system subunit 902c can take automated actions to manage condition where such capability has been designed into the systems of the marine vessel 184, or advise system operators to possible operations activities to manage pressure, which may include an increase in the frequency of using PLNG as fuel.

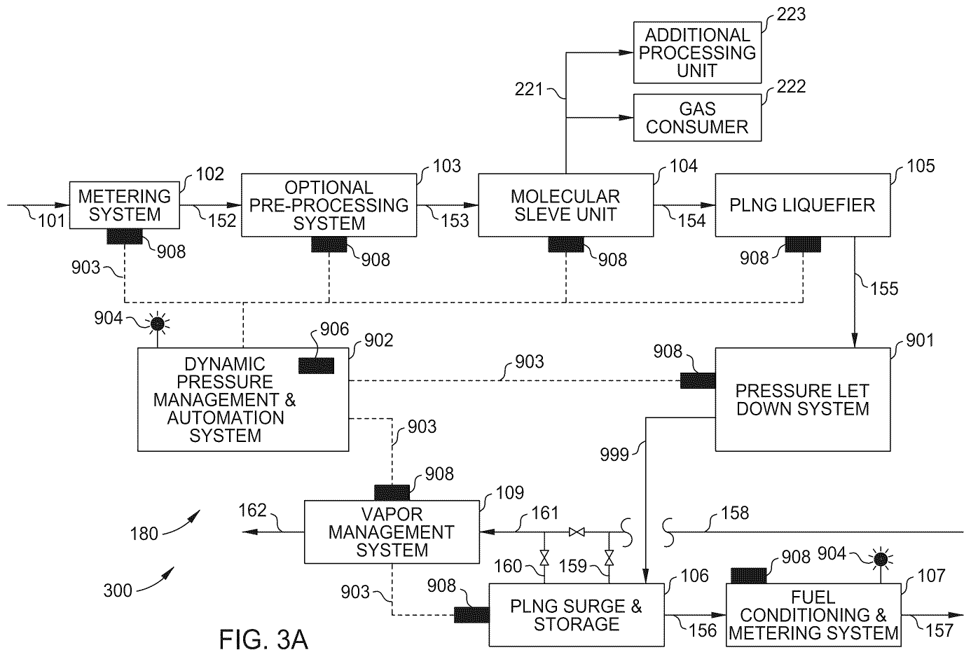

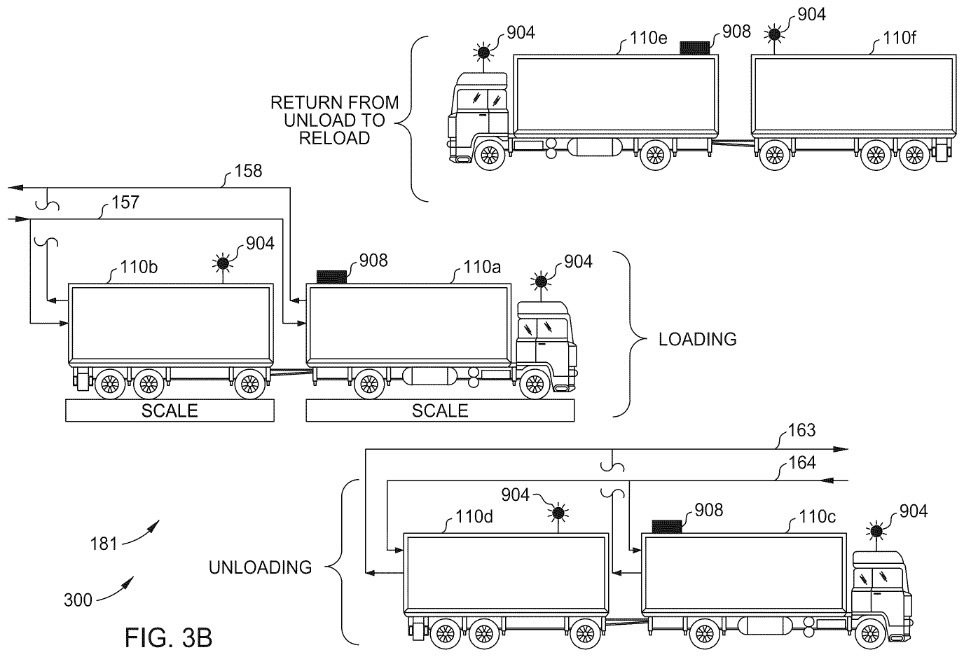

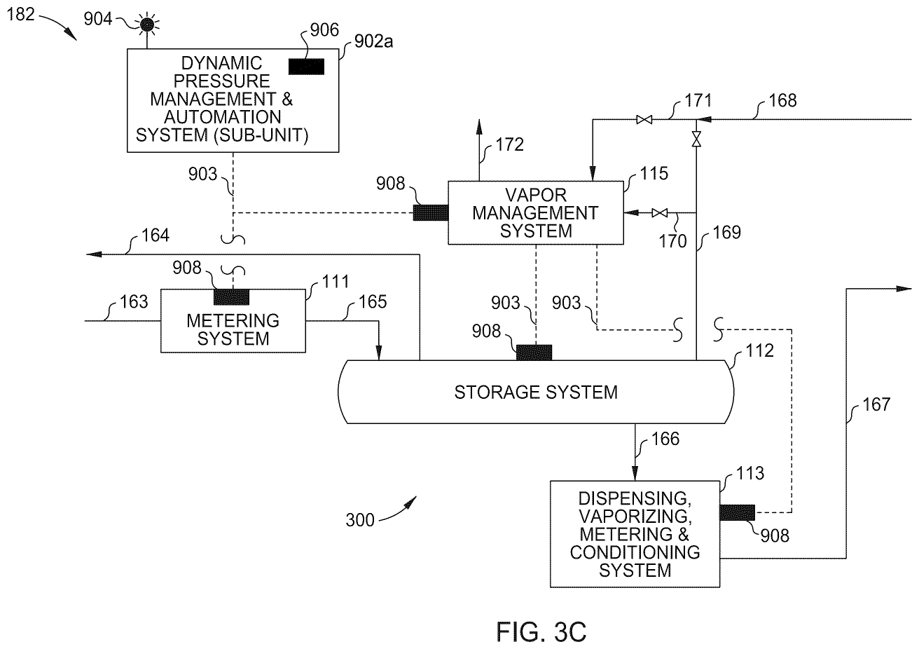

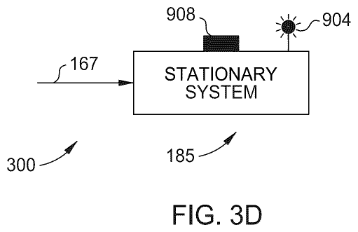

FIGS. 3A-3D illustrate schematic views of different sections of a PLNG supply chain 300 using land transport vehicles to deliver PLNG to a remote stationary application, according to one or more embodiments. The PLNG supply chain 300 includes the same PLNG production system 180, PLNG transfer system 181, and PLNG storage system 182 as in the PLNG supply chain 100 illustrated in FIGS. 1A-1C. A full description of the PLNG production system 180, the PLNG transfer system 181, and the PLNG storage system 182 will not be repeated herein for brevity.

With reference to FIG. 3D, the PLNG can be pumped via fluid line 167 to a stationary system 185, which may be a natural gas consumer or a pipeline, which may not need any vapor return lines. The stationary system 185 can also be equipped with one or more sensors 908 configured to measure one or more operational conditions, such as the pressure and temperature levels within any one or more components of the stationary system 185, one or more pressure and flow regulating devices configured to adjust the pressure within the components, and/or one or more antennas 904 configured to communicate with the control unit 906 of the dynamic pressure management and automation system 902 illustrated in FIG. 3A. Based on the operational conditions of the components of the various systems, such as pressure and temperature, the dynamic pressure management and automation system 902 can take automated actions to manage condition where such capability has been designed, such as into the stationary system 185, or advise system operators to possible operations activities to manage pressure.

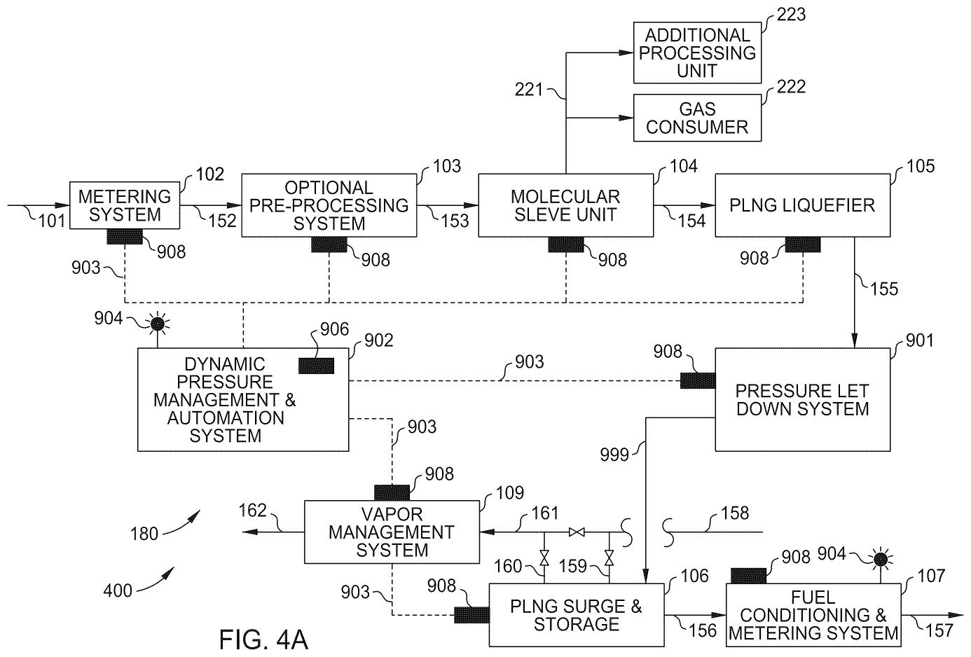

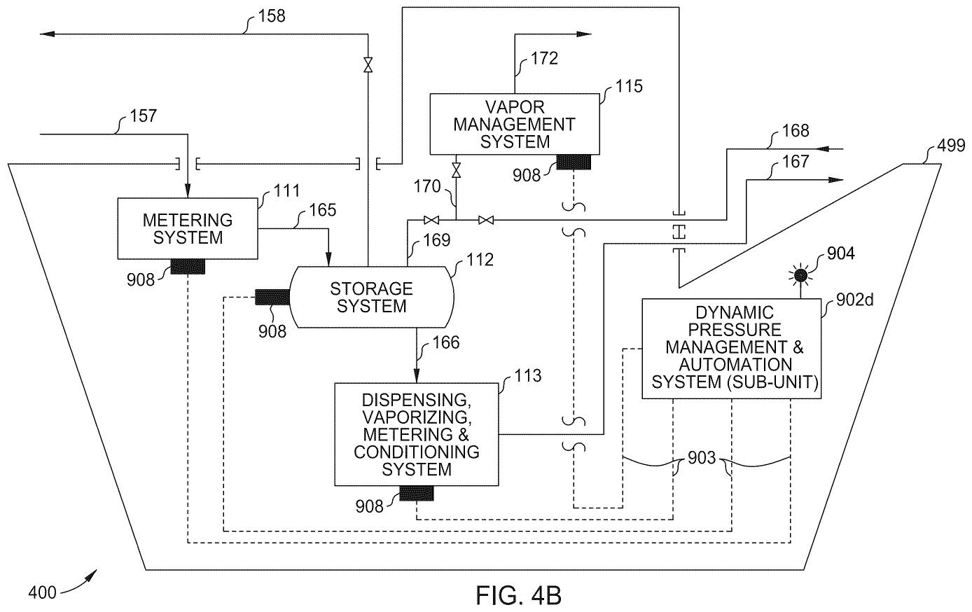

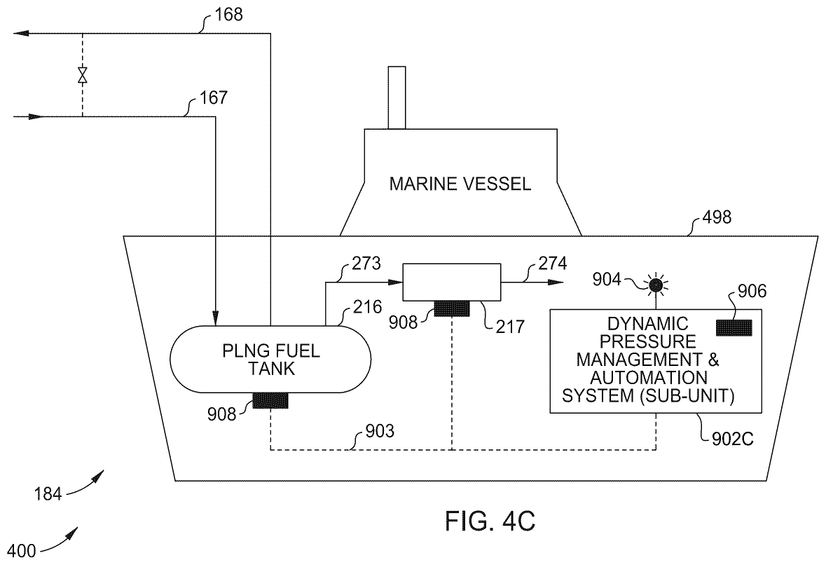

FIGS. 4A-4C illustrate schematic views of different sections of a PLNG supply chain 400 for marine vessels with marine bunkering, according to one or more embodiments. The PLNG supply chain 400 includes the same PLNG production system 180 and marine vessel 184 as in the PLNG supply chain 200 illustrated in FIGS. 2A and 2B. A full description of the PLNG production system 180 and the marine vessel 184 will not be repeated herein for brevity.

With reference to FIGS. 4B and 4C, the PLNG supply chain 400 also includes a marine bunkering vessel 499, which contains a metering system 111, a storage system 112, a dispensing, vaporizing, metering, and conditioning system 113, and vapor management system 115 similar to the PLNG storage system 182 illustrated in FIG. 1C (a full description of which will not be repeated for brevity), that dispenses the PLNG to the marine vessel 184 via fluid line 167. The marine bunkering vessel 499 may be in the form of a tanker equipped with one or more fuel storage tanks (e.g. storage system 112 configured to store PLNG at 6 bar-g or higher, such as within a pressure range of 6 bar-g to 20 bar-g), fuel transfer systems (e.g. dispensing, vaporizing, metering, and conditioning system 113), and possibly a crane for handling hoses (e.g. fluid lines 157, 158, 167, 168) for the purpose of loading fuels into marine vessels and ship tanks (e.g. marine vessel 184). The marine bunkering vessel 499 facilitates the transfer of marine fuels, including PLNG and possibly various other grades such as Low Sulfur Fuel Oil (LSFO), High Sulfur Fuel Oil (HSFO), Low Sulfur Marine Gas Oil (LSMGO), and Liquefied Natural Gas (LNG), to other ships either at port or through ship-to-ship (STS) operations at sea.

The marine bunkering vessel 499 may also include a dynamic pressure management and automation system subunit 902d for managing and dynamically adjusting pressures within the marine bunkering vessel 499. The dynamic pressure management and automation system subunit 902d operates in a similar manner as the dynamic pressure management and automation system 902 illustrated in FIGS. 1A and 4A, and communicates via communication lines 903 and/or one or more antennas 904 between the control unit 906, the sensors 908, and the pressure and flow regulating devices. The dynamic pressure management and automation system subunit 902d can also communicate with the dynamic pressure management and automation system 902 illustrated in FIG. 4A via the one or more antennas 904 to share operational conditions, such as pressure and temperature measurements, of the various components of the systems. Based on one or more operational conditions of the various components of the systems, such as pressure and temperature, the dynamic pressure management and automation system subunit 902d can take automated actions to manage condition where such capability has been designed, such as into the systems of the marine bunkering vessel 499, or advise system operators to possible operations activities to manage pressure, which may include an increase in the frequency of loading PLNG fuel to customers such as the marine vessel 184, or to use some PLNG fuel for its own operation onboard the marine bunkering vessel 499.

Any one or more components and/or sections of the supply chains 100, 200, 300, 400 may be integrally formed together, directly coupled together, and/or indirectly coupled together and are not limited to the specific arrangements illustrated in the Figures. Any of the one or more embodiments of the supply chains 100, 200, 300, 400 may be combined, in whole or in part, with any of the other one or more embodiments of the supply chains 100, 200, 300, 400.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The disclosure also contemplates that one or more aspects of the embodiments described herein may be substituted in for one or more of the other aspects described.

While the foregoing is directed to embodiments of the present disclosure, other and further embodiments of the disclosure may be devised without departing from the basic scope thereof, and the scope thereof is determined by the claims that follow.

1. A pressurized liquefied natural gas (PLNG) system for producing, storing, transporting, and utilizing PLNG for mobile applications, comprising:
a production system configured to receive natural gas and produce PLNG at a pressure within a range of 6 bar-g to 20 bar-g; and
a mobile fuel system configured to receive the PLNG from the production system and maintain the PLNG at the pressure within the range of 6 bar-g to 20 bar-g.

2. The PLNG system of claim 1, wherein the mobile fuel system is a mobile vehicle having a PLNG fuel tank configured to receive the PLNG from the production system and maintain the PLNG at the pressure within the range of 6 bar-g to 20 bar-g.

3. The PLNG system of claim 1, wherein the mobile fuel system is amarine vessel having a PLNG fuel tank configured to receive the PLNG from the production system and maintain the PLNG at the pressure within the range of 6 bar-g to 20 bar-g.

4. The PLNG system of claim 1, further comprising a transfer system configured to receive the PLNG from the production system and transport the PLNG at the pressure within the range of 6 bar-g to 20 bar-g to the mobile fuel system.

5. The PLNG system of claim 4, wherein the transfer system comprises one or more transport vehicles having one or more tanks configured to transport the PLNG at the pressure within the range of 6 bar-g to 20 bar-g to the mobile fuel system.

6. The PLNG system of claim 4, further comprising a storage system configured to receive the PLNG from the transfer system, store the PLNG at the pressure within the range of 6 bar-g to 20 bar-g, and supply the PLNG to the mobile fuel system.

7. The PLNG system of claim 1, further comprising a marine bunkering vessel configured to receive the PLNG from the production system, store the PLNG at the pressure within the range of 6 bar-g to 20 bar-g, and supply the PLNG to the mobile fuel system.

8. The PLNG system of claim 1, wherein the production system comprises a molecular sieve unit configured to dehydrate natural gas, and a PLNG liquefier downstream of the molecular sieve unit configured to liquefy the dehydrated natural gas into PLNG at the pressure within a range of 5 bar-g to 20 bar-g.

9. The PLNG system of claim 8, wherein the PLNG liquefier comprises a nitrogen recovery system configured to remove nitrogen from the dehydrated natural gas.

10. The PLNG system of claim 8, wherein the PLNG liquefier comprises a natural gas liquids and heavy hydrocarbon recovery system configured to remove natural gas liquids and heavy hydrocarbons from the dehydrated natural gas.

11. The PLNG system of claim 1, wherein the production system comprises a contaminant removal system configured to remove contaminants from the natural gas.

12. The PLNG system of claim 1, wherein the production system comprises a vapor management system configured to manage displaced vapor from the production system.

13. A pressurized liquefied natural gas (PLNG) system for producing, storing, land-vehicle transporting, and utilizing PLNG for stationary applications, comprising:
a production system configured to receive natural gas and produce PLNG at a pressure within a range of 6 bar-g to 20 bar-g; and
a stationary system configured to receive the PLNG from the production system and maintain the PLNG at the pressure within the range of 6 bar-g to 20 bar-g.

14. The PLNG system of claim 13, wherein the stationary system is a natural gas consumer or a pipeline.

15. The PLNG system of claim 13, further comprising a transfer system configured to receive the PLNG from the production system and transport the PLNG at the pressure within the range of 6 bar-g to 20 bar-g to the stationary system.

16. The PLNG system of claim 15, wherein the transfer system comprises one or more transport vehicles having one or more tanks configured to transport the PLNG at the pressure within the range of 6 bar-g to 20 bar-g to the stationary system.

17. The PLNG system of claim 16, further comprising a storage system configured to receive the PLNG from the transfer system, store the PLNG at the pressure within the range of 6 bar-g to 20 bar-g, and supply the PLNG to the stationary system.

18. The PLNG system of claim 13, wherein the production system comprises a molecular sieve unit configured to dehydrate natural gas, and a PLNG liquefier downstream of the molecular sieve unit configured to liquefy the dehydrated natural gas into PLNG at the pressure within a range of 5 bar-g to 20 bar-g.

19. The PLNG system of claim 18, wherein the PLNG liquefier comprises a nitrogen recovery system configured to remove nitrogen from the dehydrated natural gas.

20. The PLNG system of claim 18, wherein the PLNG liquefier comprises a natural gas liquids and heavy hydrocarbon recovery system configured to remove natural gas liquids and heavy hydrocarbons from the dehydrated natural gas.

21. The PLNG system of claim 13, wherein the production system comprises a contaminant removal system configured to remove contaminants from the natural gas.

22. The PLNG system of claim 13, wherein the production system comprises a vapor management system configured to manage displaced vapor from the production system.

23. A method of dynamically managing pressures within a pressurized liquefied natural gas (PLNG) supply chain, comprising:
monitoring one or more operational conditions of a pressurized tank containing PLNG at a pressure within a range of 6 bar-g to 20 bar-g via one or more sensors;
receiving a signal corresponding to the one or more operational conditions from the one or more sensors; and
adjusting pressure within the pressurized tank based on the one or more operational conditions.

24. The method of claim 23, wherein the one or more operational conditions comprise at least one of temperature and pressure within the pressurized tank.

25. The method of claim 23, wherein the pressure within the pressurized tank is adjusted by a pressure let down system in fluid communication with pressurized tank.

26. The method of claim 23, further comprising advising system operators to adjust the pressure within the pressurized tank based on the one or more operational conditions.

27. The method of claim 23, wherein the pressurized tank is a storage tank, a transfer tank, or an on-board fuel tank.

28. The method of claim 23, further comprising adjusting the pressure within the pressurized tank based on the one or more operational conditions to:
minimize boil-off rates of the PLNG within the pressurized tank during transport or storage;
prevent pressure drop within the pressurized tank during transfer of the PLNG to or from the pressurized tank;
ensure compatibility with fuel systems operating at elevated pressures; or
prevent overpressure conditions and methane emissions from the pressurized tank.
